(19) United States
(12) Patent Application Publication
(10) Pub. No.: US 2002/0037018 A1
(43) Pub. Date: Mar. 28, 2002

(54) Apparatus and method for reducing the line rate of time-multiplexed signals

(76) Inventors: Anthony L. Lentine, Holmdel, NJ (US); Graham H. Smith, Jersey City, NJ (US); Ted K. Woodward, Holmdel, NJ (US)

Correspondence Address: John A. Caccuro, 9 Ladwood Drive, Holmdel, NJ, 07733, US

(21) Appl. No.: 09/862,573

(22) Filed: May 21, 2001

Related U.S. Application Data
(60) Provisional application No. 60/235,642, filed on Sep. 26, 2000.

(51) Int. Cl. H04J 3/00; H04J 3/04

(52) U.S. Cl. 370/521; 370/535; 370/540

(57) ABSTRACT

An apparatus and method for enabling the transport of a higher line rate time-multiplexed data signals (e.g., Ethernet at 10 Gb/s) at a lower line rate (e.g., SONET OC-192) and for regenerating the higher line rate time-multiplexed data signals at the receiving end. At a transmitter end, a data stream compression apparatus removes a predetermined portion of non-unique, invariant content of the higher line rate data stream thereby generating the lower line rate data stream which is transmitted over a communication link to the receiver end. At the receiver end, a data stream expansion apparatus adds back the missing predetermined portion of non-unique, invariant content to the lower line rate data stream thereby regenerating the higher line rate data stream. A data compression multiplexer apparatus is formed by combining a plurality of the data stream compression apparatuses with a data multiplexer. A data expansion demultiplexer apparatus is formed by combining a data demultiplexer with a plurality of the data stream expansion apparatuses.

### RELATED APPLICATION

This application is based on a provisional application, Ser. No. 60/235,642 filed on Sep. 26, 2000 and entitled “METHOD FOR REDUCING THE LINE RATE OF TIME-MULTIPLEXED GBE SIGNALS.”

### TECHNICAL FIELD OF THE INVENTION

This invention relates to time-multiplexed signal transmission, and more particularly to an apparatus and a method for reducing the line rate of such signals.

### BACKGROUND OF THE INVENTION

There is a continuing problem of the transport of multiplexed gigabit (Gb) Ethernet data signals over well-known long haul transmission facilities so as to maintain its 8 bit/10 bit coding format. Such data streams operate at a line rate of 1.25 Gb/s. To increase transport efficiency, it is desirable to time-multiplex eight of these data steams together leading to a line rate of 10.000 Gb/s. It is further desirable to transport these data streams over facilities at the well-known SONET (Synchronous Optical Network) OC-192 line rate of 9.953 Gb/s.

Prior aggregating protocols for gigabit Ethernet either specified wavelength division multiplexing or multiple fiber links, all of which do not provide time-multiplexing of the signals. Previous time-multiplexed data transmission typically involves recoding or protocol conversion. These prior time-multiplexed data links either do not reduce the line rate below 10.000 Gb/s, or remove all 8 b/10/b information and re-frame data with alternative data link protocol, such as SONET.

What is desired is a technique for transporting a higher line rate time-multiplexed Ethernet data signal (e.g., 10 Gb/s) at a lower line rate SONET OC-192.

### SUMMARY OF THE INVENTION

In accordance with the present invention, an apparatus and method are disclosed for the transport of a higher line rate time-multiplexed data signals (e.g., Ethernet at 10 Gb/s) at a lower line rate (e.g., SONET OC-192) and regenerating the higher line rate time-multiplexed data signals at the receiving end. At a transmitter end, a data stream compression apparatus removes a predetermined portion of non-unique, invariant content of the higher line rate data stream thereby generating the lower line rate data stream which is transmitted over a communication link to the receiver end. At the receiver end, a data stream expansion apparatus adds back the missing predetermined portion of non-unique, invariant content to the lower line rate data stream thereby regenerating the higher line rate data stream.

More specifically, our invention is directed to a data stream compression apparatus comprising (1) a data stream processing element for receiving a first stream of data entities at a first line rate, each data entity including a data packet and a gap (whose length in the most general case may be zero), and responsive to a control signal for generating a second stream of data entities at a second line rate which is less than the first line rate, (2) a control element, for providing said control signal, identifying a predetermined portion of non-unique, invariant content of said first stream of data entities, and (3) wherein said data stream processing element in response to said control signal removes said predetermined portion of non-unique, invariant content of said first stream of data entities thereby generating said second data stream of data entities at the second line rate.

According to another aspect of our invention, a data stream expansion apparatus comprises (1) a data stream processing element for receiving a second data stream of data entities at a second line rate and responsive to a control signal for generating a first stream of data entities at a first line rate which is greater than the second line rate, (2) a control element for providing said control signal identifying a predetermined portion of non-unique, invariant content which is to be added to said second data stream of data entities, and (3) wherein said data stream processing element in response to said control signal adds said predetermined portion of non-unique, invariant content to said second data stream of data entities thereby generating said first data stream of data entities at the first line rate.

In another embodiment, our invention is directed a data communication system including a data stream compression apparatus connected over a communication link to a data stream expansion apparatus.

In other embodiments, our invention is directed to (1) a data compression multiplexer apparatus including a plurality of data stream compression apparatus and a data stream multiplexer, (2) a data expansion demultiplexer apparatus including a data stream demultiplexer and a plurality of data stream expansion apparatuses, and (3) to a communication system including a data compression multiplexer connected over a communication link to a data expansion demultiplexer.

### BRIEF DESCRIPTION OF THE DRAWINGS

In the drawings,

FIG. 1A shows an embodiment of a data stream compression apparatus of the present invention.

FIG. 1B shows an embodiment of a data stream expansion apparatus of the present invention.

FIG. 2 illustratively shows the format of different received data streams which are processed by the present invention.

FIG. 3 shows an illustrative multiplex/demultiplex system utilizing the present invention at the transmitter and receiver locations.

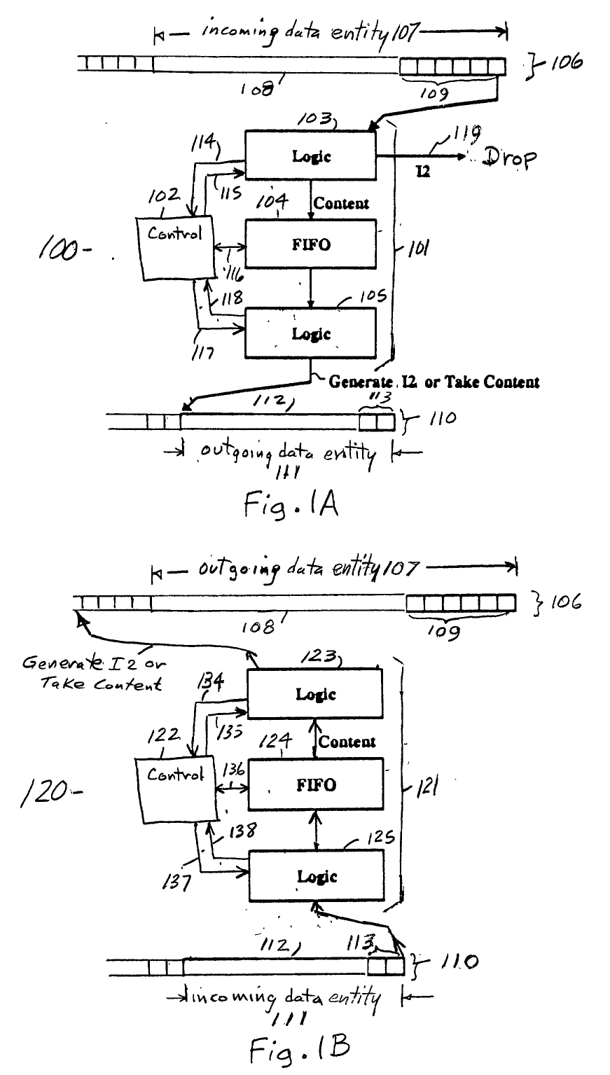

In the following description, identical element designations in different figures represent identical elements. Additionally in the element designations, the first digit refers to the figure in which that element is first located (e.g., 102 is first located in FIG. 1).

### DETAILED DESCRIPTION

With reference to FIG. 1A there is shown an embodiment of a data stream compression apparatus in accordance with the present invention. The data stream compression apparatus 100 includes data stream processing element 101 and control element 102. The data entity-processing element 101 illustratively includes a first logic element 103, a memory element—exemplified here by a First-In-First-Out (FIFO) buffer 104, and a second logic element 105.

A first stream 106 of data entities 107 is received at a first line rate, each data entity 107 including a data packet 108 and a gap 109. The gap 109 may be zero length or may contain interpacket control characters (referred to as characters I2) that are collectively referred to herein as non-unique, invariant content. The data packet 108 may contain redundant or duplicate bits, bytes, and/or packets that are also collectively referred to herein as non-unique, invariant content. For a given type of the first data stream 106 the non-unique, invariant content of the gap 109 and/or the data packets 108 is known and is stored at control unit 102.

The control unit 102, which illustratively may include a processor and memory, connects to the first logic element 103, FIFO 104, and second logic element 105. The control unit 102 receives information regarding the availability of data packets and their presence in the FIFO 104 from first logic element 103 via lead 114 and sends control signals regarding the data packets to first logic element 103 via lead 115. The control unit 102 receives and transmits information regarding FIFO 104 occupancy and addresses (if needed) over path 116. The control unit 102 receives information about the packets from second logic element 105 via lead 118 and sends control signals regarding the availability of data packets in FIFO 104, as well as any special details about the type of data, and any special actions to be taken as a consequence if required to second logic element 105 via lead 117.

The control unit 102 is preprogrammed to control the operation of the entity processing element 101 to remove some or all of the non-unique, invariant content of the first data stream 106. Since the control unit 102 has been programmed to handle the type of data stream represented by the first data stream 106, it knows where to find the non-unique, invariant content of the first data stream 106 that is to be removed. In response to signals 114 indicating the start of a data frame, control unit 102 accesses its memory to determine which non-unique, invariant content of the first data stream 106 is to be removed. The control unit 102 then controls the first logic element 105 to drop the determined non-unique, invariant content of the first data stream 106. Illustratively for convenience, the removed non-unique, invariant content of the first data stream 106 is shown being discarded via Drop lead 120. In reality, the removed non-unique, invariant content of the first data stream 106 is just not passed along to the FIFO 104. Control unit 102 controls FIFO 104, via lead 116, and second logic element 105 logic, via lead 117, to generate gap characters 12 and data packet content for the second data stream 110.

After processing by the data entity-processing element 101, the first data stream 106 with some or all of the non-unique, invariant content removed (or dropped) becomes the second data stream 110 at a reduced data rate. Since the control unit 102 knows the reduced data rate of the communication facility over which it has to transmit the second data stream 110, it has been programmed to know how much and which of the non-unique, invariant content of the first data stream 106 is to be removed. The resulting second data stream 110 has a data rate that is less than the data rate of the first data stream 106. Illustratively, the reduced data rate of the second data stream 110 is shown with data entity 111 having a reduced bit length including a smaller data packet 112 and a smaller gap 113.

In this manner, the data stream compression apparatus of FIG. 1 generates a second data stream 110 which can be sent over a communication facility that operates at or above the second data stream 110 line rate but which is lower than the first data stream 201 line rate.

At the receiver end a data stream expansion apparatus of the present invention re-inserts (or adds) the removed non-unique, invariant content into the second data stream to regenerate the first data stream. The operation of the data stream expansion apparatus 120 of FIG. 1B is essentially the reverse of the operation of the data stream compression apparatus 100 of FIG. 1A. That is, data stream expansion apparatus 120 of FIG. 1B receives the reduced rate second data stream 110 and adds back the missing non-unique, invariant content of the gap 113 and/or the data packets 112 to regenerate the first data stream 106.

With reference to FIG. 1B we describe briefly the operation of the data stream expansion apparatus 120. The data stream expansion apparatus 120 includes data stream processing element 121 and control element 122. The data entity-processing element 121 illustratively includes a first logic element 123, a First-In-First-Out (FIFO) element 124, and a second logic element 125.

A second stream 110 of data entities 111 is received at a second line rate, each data entity 131 including a data packet 112 and a gap 113. Again control unit 122 knows for a given type of the second data stream 110 the non-unique, invariant content of the gap 113 and/or the data packets 112 that has to be added to the second date stream 110 to regenerate the first data stream 106.

Since the control unit 122 has been programmed to handle the type of data stream represented by the first data stream 106, it knows what non-unique, invariant content of the first data stream 106 has to be added and where in the second data stream that it should be added. In response to signals 138 indicating the start of a data frame, control unit 122 accesses its memory to determine which non-unique, invariant content of the first data stream 106 is to be added to the second data stream 110. The control unit 122 then controls the second logic element 123 to add the determined non-unique, invariant content back to the second data stream 110. Control unit 122 controls FIFO 124, via lead 136, and second logic element 123 logic, via lead 134, to generate gap characters 12 and data packet content for the first data stream 110.

As above described, the elements of the data stream expansion apparatus 120 operate in a similar or identical manner to the corresponding element in the data compression apparatus 100. Thus, a common data processing apparatus may be implemented which can perform either the data compression or data expansion function. A control signal would indicate to the control unit whether to perform the data compression or data expansion function.

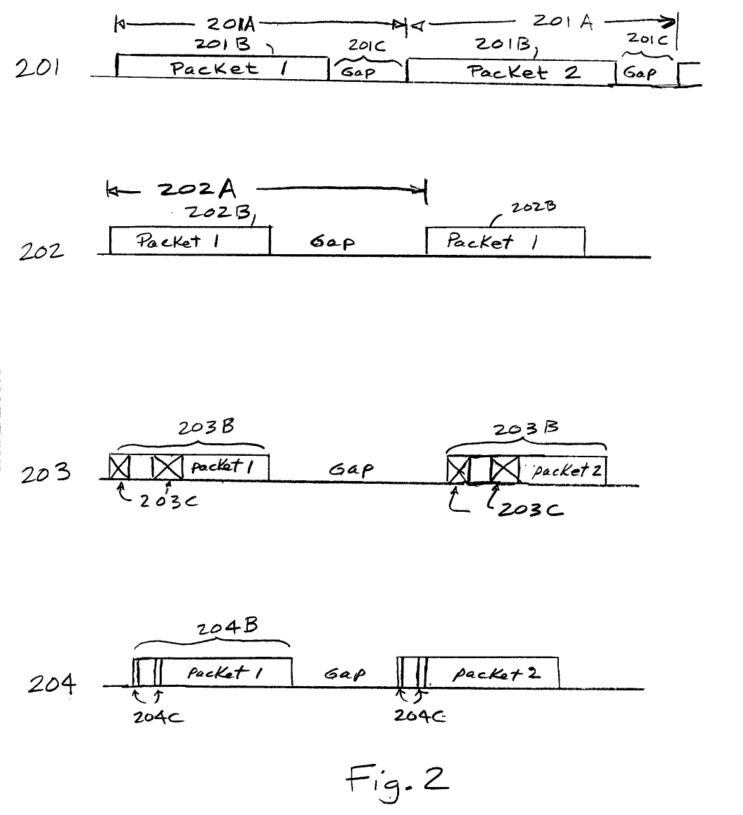

With reference to FIG. 2 there is shown, illustratively, the format of a variety of different types of received first data streams which are processed by the present invention into a variety of types of second data streams at a reduced line rate. One first data stream 201 is shown to include a plurality of identical sized data entities 201A, each having a data packet 201B and a predetermined gap 201C. The data packets 201B are shown to have different content. The predetermined gap 201C may be empty or contain idle characters. In this example, knowledge of the type of first data stream 201 determines both the length and whether the gap 201C is empty or contains predetermined content. The predetermined content of gap 201C may include one or more different types of predetermined characters (e.g., an idle character 12). The gap 201C length and whether it is empty or contains content is fixed by the identity of first data stream 201.

The illustrative data stream 202 is shown to include a known group of data entities 202A having identical data packets 202B. Again, since the data stream compression apparatus of FIG. 1A (or data expansion apparatus of FIG. 1B) knows the type of first data stream 202 that it is to handle, it knows where to find the non-unique, invariant content, i.e., the duplicate data packets 202B of the first data stream 202. The data stream compression apparatus also knows how many of the data packets 202B of the first data stream 202 are to be removed and thereby form the second data stream.

The illustrative data stream 203 is shown to include a known group of data entities 203A having non-unique, invariant one or more data bytes 203C in data packets 203B. Again, since each of the data stream compression/compression apparatuses knows the type of first data stream 203 that it is to handle it knows where to find/insert the non-unique, invariant content, i.e., the non-unique, invariant one or more data bytes 203C in the first data stream 203. The data stream compression/expansion apparatuses also knows how many of the data bytes 203C are to be removed-from/added-to first/second data stream to form a second/first data stream, respectively.

The illustrative data stream 204 is shown to include a known group of data entities 204A having non-unique, invariant one or more data bits 204C in data packets 204B. Again, since the data stream compression/expansion apparatuses know the type of first data stream 204 that it is to handle it knows where to find/insert the non-unique, invariant content, i.e., the identical one or more data bits 204C in the first data stream 204. The data stream compression/expansion apparatuses also knows how many of the data bits 204C are to be removed-from/added-to first/second data stream to form a second/first data stream, respectively.

Returning to FIG. 1A we describe the operation of data entity processing element 101 under control of control unit 102. The data entity processing element 101 stores only data packets 107, the gap content is removed via lead 120. The gap 113 needed for the second data stream is generated in logic element 105. When a packet appears in FIFO 104, logic element 105 finishes generating the bits of the current gap 113 and any additional bits required. Note, to prevent under runs from FIFO 104, a few bits of the data packets 107 are allowed to accumulate in FIFO 104 before the data packets 107 are taken from FIFO 104. The exact number of bits allowed to accumulate depends on the difference between the data rate of the first data stream and the data rate of the second data stream. Between successive data packets 107, the FIFO 104 will run empty.

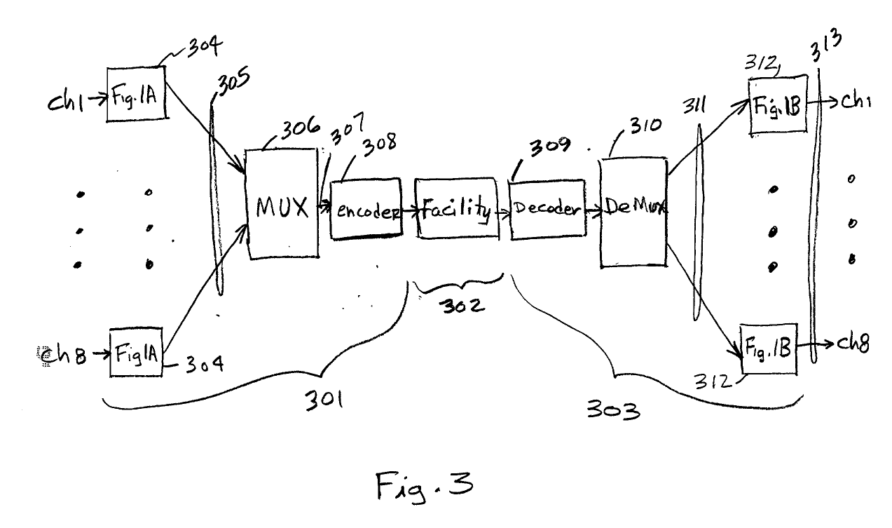

With reference to FIG. 3, in accordance with one embodiment of the invention, our data stream compression apparatus of FIG. 1A may be utilized as part of a multiplexer apparatus 306 and the data stream expansion apparatus of FIG. 1B may be utilized as part of a demultiplexer apparatus 310. FIG. 3 illustrates a multiplex/demultiplex communication system including a transmitter location 301, a transmission link (or facility, or network) 302, and a receiver location 303.

At the transmitter location 301, each of eight data channel uses a data stream compression apparatus 304 (of FIG. 1) to compress eight of the first data streams, ch 1-8, into eight reduced rate second data streams 305, in the manner previously described in FIG. 1A. The multiplexer 306 multiplexes together the eight reduced rate second data streams 305 into a time-multiplexed signal 307. Depending on the type of communication facility 302 utilized, an encoder 308 may be required to adapt the signal for transmission over the link 302. For example, if the link 302 is an optical link, encoder 308 is an electrical to optical converter (e.g., laser).

At the receiver location 302, if the link 302 is an optical facility, a decoder 309 is used to detect or convert the signal from optical to an electrical signal (e.g., photo diode). A demultiplexer 310 demultiplexes the detected signal into the eight constituent second data streams 311, which are each expanded by our data stream expansion apparatus 312 of FIG. 1B to regenerate each of the original first data streams 313. Thus, the received channels, ch 1-8, are identical to the transmitted channels, ch 1-8.

In one particular application of the system of FIG. 3, we consider the transporting of an 8 channel time-multiplexed 8 b/10 b-coded gigabit Ethernet data streams (GbE standard) over a well-known SONET OC-192 data link which operates at 9.953 Gb/s. In accordance with the present invention, our data stream compression apparatus of FIG. 1B ensures 100 percent availability to all of the 8 input channels. In this example, each of data channels, ch 1-8 of FIG. 3, is an 8 b/10 b coded gigabit Ethernet data streams (a ‘first data stream’ of FIG. 1A). After data stream compression 304 the resulting eight ‘second data streams’, 305 of FIG. 3, are then multiplexed together by multiplexer 306 to become a time-multiplexed 9.953 Gb/s signal 307. As previously described, our technique removes (or drops) some or all of the non-unique, invariant parts of each first data stream (each input ch 1-8 of FIG. 3). Generally, this non-unique, invariant information generally falls between packets (i.e., in the gap) and may be referred to as interpacket control characters. Such characters may consist of IDLE2 (I2) characters specified in the Gigabit Ethernet standard, and/or PREAMBLE characters preceding the start of frame identifier. The Gigabit Ethernet standard is well known, for example see the document entitled “IEEE standard 802.3” which is incorporated by reference herein.

Since each of the 8 gigabit Ethernet data streams operate at 1.25 Gb/s each, merely multiplexing them together without compression would produce a 10.000 Gb/s signal. Since the data link 302 has only a 9.953 Gb/s data rate, sufficient numbers of IDLE2 and/or PREAMBLE characters (or other non-unique, invariant characters) need to be removed from each of the 1.25 Gb/s Ethernet data streams to reduce the multiplexed data rate by at least 0.047 Gb/s (10.000 Gb/s-9.953 Gb/s). This amounts to an approximate 0.5 percent data rate reduction for each 1.25 Gb/s Ethernet data stream.

A specific implementation of the logic circuit 103 is achieved by constructing a template matching algorithm which fails to place into FIFO 104 any content that matches the template, which represents the known non-unique content. Such an implementation is easily made in programmable electronic logic elements that are readily available on the commercial market and capable of operating at the speeds required for the illustrative example. As a specific example, a GbE data stream operates at a serial line rate of 1.25 Gb/s. Commercial serializer/deserializer (SERDES) devices are capable of converting this serial stream to a bit-parallel stream at 10× lower speed (125 Mhz). At this rate, programmable devices, field programmable gate arrays (FPGAs) or complex programmable logic devices (CPLDs) are readily available that can accept the data and operate upon it with user-defined functions of the type required for this operation.

Additionally, on the ‘far’ side of the FIFO 104, the logic element 105 simply transmits a desired character(s) when no information is present in FIFO 104, or otherwise receives the FIFO content and transmits this information. At the receiving end, the logic element 125 can detect the aforementioned link characters in the same manner as logic element 105 (a prior since they were put into the link by the system).

Similar to logic element 105, logic element 123 is programmed to generate the appropriate non-unique content that was removed by logic element 103. For example—in the case where gap characters are omitted in elements 103-105, element 123 generates these gap characters until a packet is detected in FIFO 124, after which the FIFO content can be inserted into the outgoing stream after a known predetermined amount of the gap has been generated. A similar method can be applied to the reinsertion of non-unique content within the packet—so long as the logic element 123 is signaled to insert the content. This signal can be generated in real time by elements 122-125 by pattern matching to the data stream and detecting known signals that indicate that an appropriate non-unique character sequence is to be created, or may be generated automatically upon detection of FIFO 124 data, based on predetermined rules for data transmission. For example, in a GbE stream it is known that a specific number of so-called ‘Preamble’ bytes are present in specific locations after the start of the data packet, which is typically delineated with a ‘start of frame’ delimeter. One could rely upon this fact for regenerating the Preamble bits after detecting the start of frame delimeter in the data in the FIFO 124. Alternatively—logic element 105 could have inserted a single code word into the link during the course of transmitting the FIFO 104 entities that indicated the position of the required preamble stream, whose detection by element 122 or 125 would signal element 123 to regenerate these bytes.

As will be discussed below, even with maximal length data packets with minimal length interframe (or interpacket), our data stream compression apparatus of FIG. 1A can remove sufficient amounts of these IDLE2 and/or PREAMBLE characters to reduce the data rate of the 1.25 Gb/s Ethernet data stream by the required 0.5 percent.

The Add/Drop synchronization between the compression apparatus (304 of FIG. 3) and the expansion apparatus (312 of FIG. 3) occurs as described below. For our gigabit Ethernet (GbE) data stream example, we first assume that all packets enter the compression apparatus with 96 ns IFG (Inter Frame Gap) and may leave with as little as 64 ns IFG. We also assume that the clients at the endpoints of the system (Ch1-8 connected to elements 304 and 312, respectively) comprise GbE clients whose output clock frequencies are matched to one another within the tolerance of the GbE standard. The system of FIG. 3 must then ensure a 100 percent throughput of the packets through link 301-302, 303.

The oscillator accuracy of the GbE standard is 200 ppm (parts per million). For a maximal length packet of duration 1542 bytes, (maximum duration when IEEE 802.1 Q priority tag fields are included), removing two interframe gap characters (32 ns), permits a periodicity reduction of 32 ns out of 12336, or 2594 ppm, far in excess of the maximum clock rate variation between successive GbE clocking domains. It is therefore clear that the endpoints of the link 308 can be matched to one another by this method. Such a modified GbE packet would still be compliant to the GbE standard, which specifies that a receiver must accept packets having a minimum of 4 interframe characters. We next consider if 100 percent link utilization can be accomplished on the facility side (302) of the link for the multiplexed signal whose natural frequency would be (as previously mentioned) 10.000 GHz (clock rate) over a 9.953 GHz link. As the above calculation indicates, if a 96 ns IFG is required in a system (for example in a system having routers which require 96 ns interframe between all output packets), then link utilization is not 100 percent. The reduced 99.95 percent link rate may be sufficient in certain applications.

The present invention, however, enables 100 percent link utilization of a 10.000 Gb/s line rate signal over a 9.953 Gb/s link if the interframe gap can be reduced somewhat. For example, this can be accomplished if we reduce the interframe gap to 32 ns, on the proprietary side of the link network 302. In the example arrangement of FIG. 3, the proprietary side of the network is at the transmitter location 301 and the receiver location 303. As previously discussed the interframe gap 113 in the output data stream 110 may be reduced to 32 ns, or 2 characters, by removing 64 ns of non-unique information. This could be 4 interframe characters (8 bytes), or a combination of interframe and Preamble bytes taken from the incoming data stream 106. Removing or dropping this amount of information leads to a reduction in timing of at least 5188 ppm, for a continuous stream of maximal length packets. This is sufficient for a multiplexed data link combining 8 GbE signals to operate at a clock frequency of 9.948 GHz. Since the data rate of the 9.953 Gb/s link exceeds the 9.948 Gb/s maximum data rate required, a 100 percent link utilization rate is achieved.

What is claimed is

1. A data stream compression apparatus comprising
a data stream processing element for receiving a first stream of data entities at a first line rate, each data entity including a data packet and a gap, and responsive to a control signal for generating a second stream of data entities at a second line rate which is less than the first line rate,
a control unit for providing said control signal identifying a predetermined portion of non-unique, invariant content of said first stream of data entities, and
wherein said data stream processing element in response to said control signal removes said predetermined portion of non-unique, invariant content of said first stream of data entities thereby generating said second data stream of data entities at the second line rate.

2. The data stream compression apparatus of claim 1 wherein the non-unique, invariant content of said first data stream is determined in real-time.

3. The data stream compression apparatus of claim 1 wherein the non-unique, invariant content includes one or more interpacket characters.

4. The data stream compression apparatus of claim 1 wherein said first data stream is gigabit Ethernet data stream and the non-unique, invariant content includes one or more PREAMBLE characters.

5. The data stream compression apparatus of claim 1 wherein said first data stream is gigabit Ethernet data stream and the non-unique, invariant content includes one or more IDLE2 characters.

6. The data stream compression apparatus of claim 1 wherein said non-unique, invariant content of said first stream of data entities has been predetermined.

7. The data stream compression apparatus of claim 1 being part of a data communication system including said data stream compression apparatus connected to transmit said second data stream over a communication link to a data stream expansion apparatus, said data stream expansion apparatus comprising
a data stream processing element for receiving said second data stream of data entities from the communication link at a second line rate and responsive to a control signal for generating a first stream of data entities at a first line rate which is greater than the second line rate,
a control unit for providing said control signal identifying a predetermined portion of non-unique, invariant content which is to be added to said second data stream of data entities, and
wherein said data stream processing element in response to said control signal adds said predetermined portion of non-unique, invariant content to said second data stream of data entities thereby generating said first data stream of data entities at the first line rate.

8. A data stream expansion apparatus comprising
a data stream processing element for receiving a second data stream of data entities at a second line rate and responsive to a control signal for generating a first stream of data entities at a first line rate which is greater than the second line rate,
a control unit for providing said control signal identifying a predetermined portion of non-unique, invariant content which is to be added to said second data stream of data entities, and
wherein said data stream processing element in response to said control signal adds said predetermined portion of non-unique, invariant content to said second data stream of data entities thereby generating said first data stream of data entities at the first line rate.

9. The data stream compression apparatus of claim 8 wherein the non-unique, invariant content of said first data stream is determined in real-time.

10. The data stream compression apparatus of claim 8 wherein the non-unique, invariant content includes one or more interpacket characters.

11. The data stream compression apparatus of claim 8 wherein said first data stream is gigabit Ethernet data stream and the non-unique, invariant content includes one or more PREAMBLE characters.

12. The data stream compression apparatus of claim 8 wherein said first data stream is gigabit Ethernet data stream and the non-unique, invariant content includes one or more IDLE2 characters.

13. The data stream compression apparatus of claim 8 wherein said non-unique, invariant content of said first stream of data entities has been predetermined.

14. A data compression multiplexer apparatus comprising
(1) a plurality of data stream compression apparatuses, each comprising
a data stream processing element for receiving a first data stream of data entities at a first line rate, each data entity including a data packet and a gap, and responsive to a control signal for generating a second stream of data entities at a second line rate which is less than the first line rate,
a control unit for providing said control signal identifying a predetermined portion of non-unique, invariant content of said first stream of data entities, and
wherein said data stream processing element in response to said control signal removes said predetermined portion of non-unique, invariant content of said first stream of data entities thereby generating said second data stream of data entities at the second line rate, and
(2) a data stream multiplexer for multiplexing said plurality of second data streams to generate a multiplexed data stream.

15. The data compression multiplexer apparatus of claim 14 including
eight data stream compression apparatuses,
wherein each said first data stream is a gigabit Ethernet data stream at 1.25 Gb/s, and
wherein said multiplexed data stream generated by said data stream multiplexer is less than or equal to the SONET OC-192 line rate.

16. The data compression multiplexer apparatus of claim 14 being part of a data communication system including said data compression multiplexer apparatus connected to transmit said multiplexed data stream over a communication link to a data expansion demultiplexer apparatus, the data expansion demultiplexer apparatus comprising
(1) a data stream demultiplexer for demultiplexing a received multiplexed data stream from the communication link into a plurality of second data streams and
(2) a plurality of data stream expander apparatuses, each for processing one of the plurality of second data streams, each data stream expander apparatus including
a data stream processing element for receiving a second data stream of data entities at a second line rate and responsive to a control signal for generating a first stream of data entities at a first line rate which is greater than the second line rate,
a control unit for providing said control signal identifying a predetermined portion of non-unique, invariant content which is to be added to said second data stream of data entities, and
wherein said data stream processing element in response to said control signal adds said predetermined portion of non-unique, invariant content to said second data stream of data entities thereby generating said first data stream of data entities at the first line rate.

17. A data expansion demultiplexer apparatus comprising
(1) a data stream demultiplexer for demultiplexing a received multiplexed data stream into a plurality of second data streams and
(2) a plurality of data stream expander apparatuses, each for processing one of the plurality of second data streams, each data stream expander apparatus including
a data stream processing element for receiving a second data stream of data entities at a second line rate and responsive to a control signal for generating a first stream of data entities at a first line rate which is greater than the second line rate,
a control unit for providing said control signal identifying a predetermined portion of non-unique, invariant content which is to be added to said second data stream of data entities, and
wherein said data stream processing element in response to said control signal adds said predetermined portion of non-unique, invariant content to said second data stream of data entities thereby generating said first data stream of data entities at the first line rate.

18. The data expansion demultiplexer apparatus of claim 17 including
eight data stream expansion apparatuses,
wherein the data rate of the received multiplexed data stream is less than or equal to the SONET OC-192 line rate, and
wherein at least one of the data stream expansion apparatuses receives a second data stream from the data stream demultiplexer and generates therefrom a gigabit Ethernet data stream at 1.25 Gb/s.

19. A method of operating a data stream compression apparatus comprising the steps of:
receiving a first stream of data entities at a first line rate, each data entity including a data packet and a gap,
identifying a predetermined portion of non-unique, invariant content of said first stream of data entities, and
removing said predetermined portion of non-unique, invariant content of said first stream of data entities thereby generating said second data stream of data entities at the second line rate.

20. A method of operating a data stream expansion apparatus comprising the steps of:
receiving a second data stream of data entities at a second line rate,
identifying a predetermined portion of non-unique, invariant content which is to be added to said second data stream of data entities, and
adding said predetermined portion of non-unique, invariant content to said second data stream of data entities thereby generating said first data stream of data entities at the first line rate.
